(19) United States
(12) Patent Application Publication
(10) Pub. No.: US 2007/0223899 A1
(43) Pub. Date: Sep. 27, 2007

(54) Passive wiper assembly

(76) Inventor: Jody Snow, Garner, NC (US)

Correspondence Address: John L. Sotomayor;Suite 300, 511 Davis Drive, Morrisville, NC, 27560, US

(21) Appl. No.: 11/386,734

(22) Filed: Mar. 23, 2006

(51) Int. Cl. G03B 17/08

(52) U.S. Cl. 396/25

(57) ABSTRACT

The passive lens wiper is an apparatus for assuring that accumulated moisture is removed from a surface through directing a flow of air across a surface, such as a camera housing lens, installed on the exterior of an emergency response or mass transit vehicle. The apparatus concentrates and directs airflow generated by the motion of the vehicle across the camera housing lens to clear water from the lens while the vehicle is in motion. The passive lens wiper has no moving parts, is easily installed, and is cost effective to manufacture. The passive lens wiper may also be used in conjunction with a chemical surface treatment that decreases the surface tension of water for a quicker clearing process.

### BACKGROUND OF THE INVENTION

Clearing accumulated moisture from a surface that is used as a view port, either as a window or a lens for a camera, in current systems requires a powered wiper system or other such assembly that utilizes a movable assembly, a control mechanism, and intelligence to determine start and stop conditions. Where space for such an assembly is limited, such as very small apertures or small surface mounted equipment housings, the existing wiper systems are too cumbersome to use and too costly to install. This problem is especially evident for camera housings that are mounted on, or within the shell of, a vehicular platform. Even if wiper assemblies could be installed and powered for use on every single camera housing, the installation would be difficult and time-consuming and the cost prohibitive.

The instant invention is a novel and non-obvious means for assuring that accumulated moisture is removed from a surface, such as a camera housing lens or other view port device, integral to a mobile, vehicle platform utilizing an assembly that has no moving parts to power, is easily installable, and is cost effective to manufacture.

### SUMMARY OF THE INVENTION

The current invention provides an effective and efficient assembly for utilizing the motion of a vehicle to generate a forced air column to clean standing moisture from a surface. In the preferred embodiment, the surface to be cleaned is a camera lens, or the transparent housing surface that covers a camera lens, of a camera assembly that is surface mounted to the exterior of a mass transit vehicle. The outflow from the passive wiper is then positioned to blow air across the camera lens or surface covering a camera lens, thus clearing the desired surface of accumulated moisture during any and all motion of the vehicle.

The passive wiper is preferentially constructed of high-impact plastic, but may also be constructed of metal alloys, glass, polycarbonate, or any other material that is used to construct vehicle parts that require exposure to the elements and an ability to resist vibration of a vehicle during travel. The passive wiper has no moving parts, does not require power or control signals, and may be affixed to a camera housing through a variety of construction means including screws, adhesives, welding, or other such construction methods useful for joining together outdoor, ruggedized equipment articles.

In all embodiments, the passive wiper is a low cost alternative to powered systems for clearing moisture from surfaces using the power of the vehicle to keep essential transparent surfaces clean of moisture, providing the clearest view for images and video recorded by installed cameras on the vehicle.

### BRIEF DESCRIPTION OF THE DRAWINGS

The above objects and advantages of the present invention will become more apparent by describing in detail preferred embodiments thereof with reference to the attached drawings:

FIG. 1: Passive Wiper front intake mount

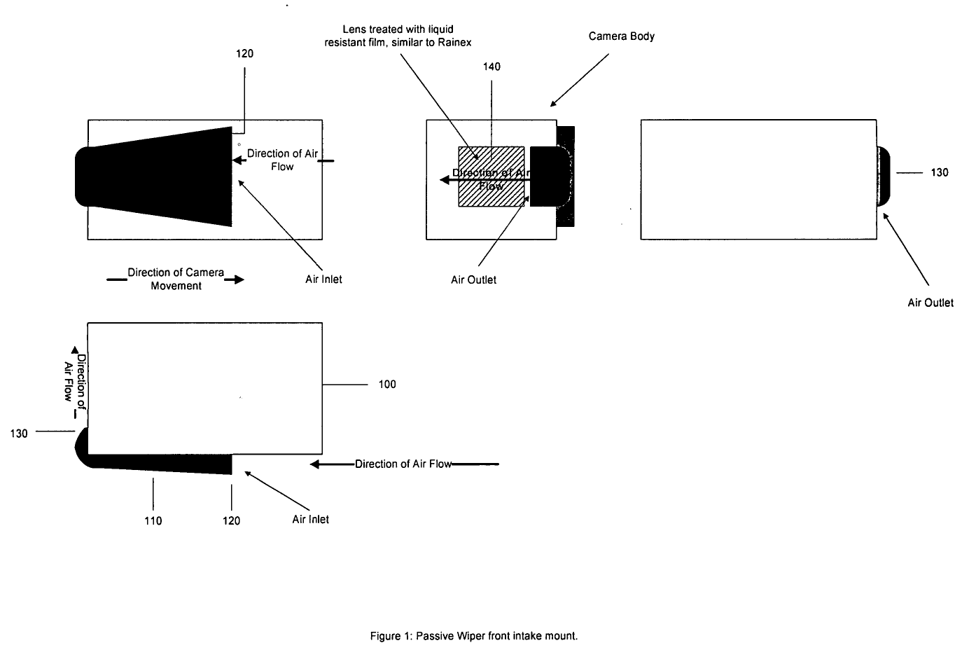

FIG. 2: Passive Wiper rear intake mount

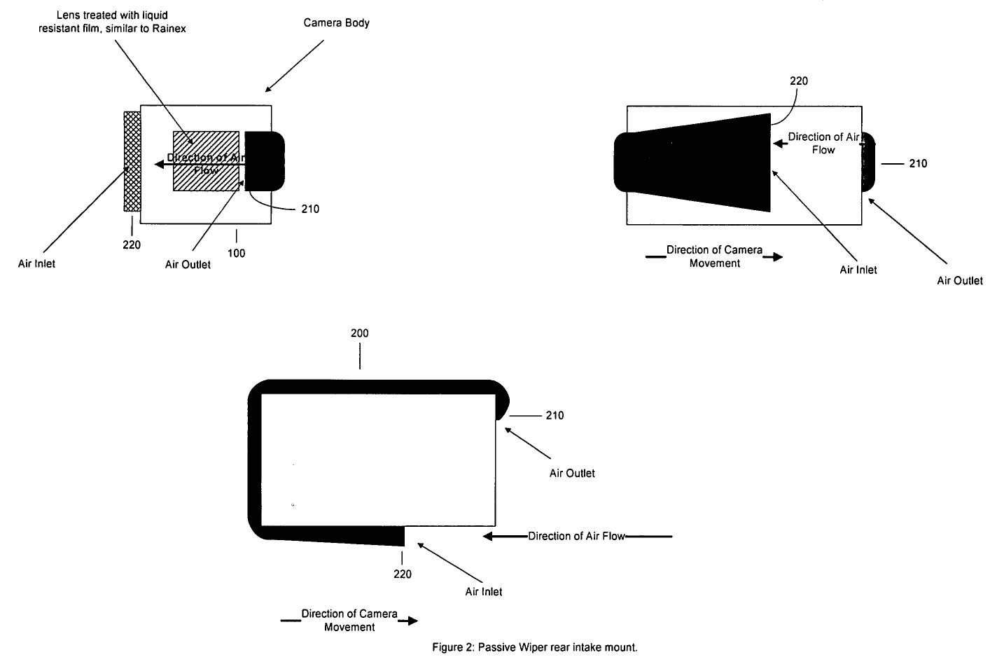

FIG. 3: Passive Wiper rear facing mount mechanical view

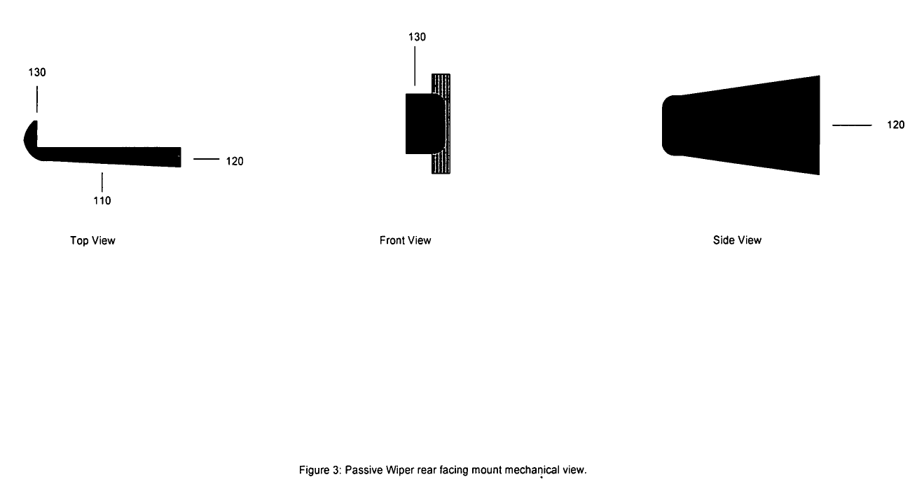

FIG. 4: Passive Wiper front facing mount mechanical view

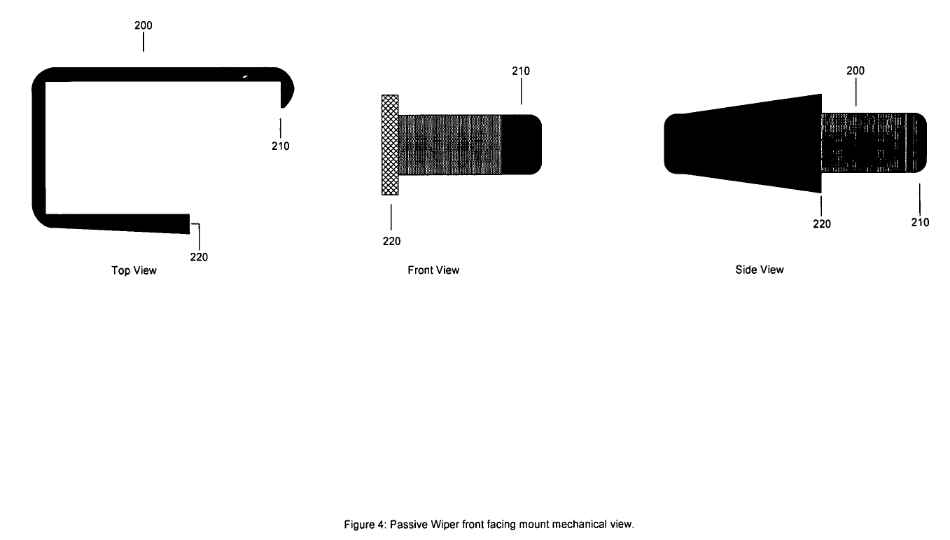

### DETAILED DESCRIPTION OF THE INVENTION

The current invention utilizes the motion of a vehicle to generate a forced air column to clean standing moisture from a surface 140. In the preferred embodiment, the surface to be cleaned is a camera lens 140, or the transparent housing surface that covers a camera lens, of a camera assembly 100 that is surface mounted to the exterior of a mass transit vehicle. The mass transit vehicle may be a service vehicle such as a police or emergency response vehicle, a bus, subway train car, light rail car, heavy rail car, or any other surface vehicle. In the preferred embodiment, the passive wiper consists of a hollow enclosure 110 with a broad opening in one terminal end of the wiper that serves as an intake opening 120. This intake 120 opening tapers until the middle of the passive wiper is approximately 50% of the width of the intake terminal end 120, with this taper serving to focus the inflowing air into a faster flowing, more forceful airflow. The passive wiper has a 90 degree bend after the wiper body has completed the taper to allow the opposite terminal end 130 to direct the forced airflow across a surface 140 when the passive wiper is affixed to the side of a camera housing 100. The outflow from the passive wiper is then positioned to blow air across the camera lens 140, or surface covering a camera lens, thus clearing the desired surface of accumulated moisture during any and all motion of the vehicle.

The passive wiper with a single 90 degree bend in the body of the wiper is used for those cameras pointed in a direction that is opposite to the direction of travel of the vehicle. A second embodiment of the passive wiper extends the body of the passive wiper and bends the wiper body through three 90 degree angles to present the intake terminal end 220 of the passive wiper to a proper airflow for those cameras that are installed such that the camera lens 140 points in the direction of motion of the vehicle. A third embodiment of the passive wiper extends the body of the passive wiper and bends the wiper body through two 90 degree angles to present the intake terminal end of the passive wiper to a proper airflow for those cameras that are installed on the sides of a vehicle, and thus are positioned such that the camera focus is perpendicular to the direction of vehicle travel.

In a further embodiment, the passive wiper may be use in conjunction with a chemical treatment of the camera lens 140, or other housing, to increase the efficiency of moisture removal from the treated surface. Treating the camera lens 140, or other housing surface, with any of a number of chemical treatments that decrease the surface tension of water, causes accumulated moisture to “bead up” and provides a quicker clearing of the accumulated moisture using the forced air from the passive wiper.

In each embodiment, the passive wiper is constructed in such a manner as to allow the wiper to be affixed to a camera housing with no interference of the mounting of said camera to the vehicle, regardless of orientation. The passive wiper is preferentially constructed of high-impact plastic, but may also be constructed of metal alloys, glass, polycarbonate, or any other material that is used to construct vehicle parts that require exposure to the elements and vibration of a vehicle during travel. The passive wiper has no moving parts, does not require power or control signals, and may be affixed to a camera housing through a variety of construction means including screws, adhesives, welding, or other such construction methods useful for joining together outdoor, ruggedized equipment articles.

While this invention has been particularly shown and described with reference to preferred embodiments thereof, it will be understood by those skilled in the art that various changes in form and details may be made therein without departing from the spirit and scope of the invention as defined by the appended claims.

We claim:

1. A passive lens wiper apparatus comprising:
A flattened, rectangular tube with four walls, a top, a bottom and two sides, with each terminal end open to provide a pathway for airflow through the flattened, rectangular tube;
Said terminal ends oriented, when the apparatus is installed, such that the first terminal end serves as an intake for air to flow into, and the second terminal end serves as an outflow for air passing through said flattened, rectangular tube;
Said intake terminal end having a width twice that of the outflow terminal end,
And the body of the wiper apparatus having at least one 90 degree bend between the intake terminal end and the outflow terminal end.

2. A passive lens wiper apparatus according to claim 1, further comprising:
Said intake terminal end tapering from a width twice that of the outflow terminal to a width equivalent to the outflow terminal prior to a 90 degree bend.

3. A passive lens wiper apparatus according to claim 1, further comprising:
Said 90 degree bend in the body of the flattened, rectangular tube positioned not less than eighty percent of the distance between the intake terminal end and the outflow terminal end.

4. A passive lens wiper apparatus according to claim 1, further comprising:
Said flattened, rectangular tube configured to be affixed to a camera housing through any of a variety of construction means including screws, adhesives, welding, or other such construction methods useful for joining together outdoor, ruggedized equipment articles.

5. A passive lens wiper apparatus comprising:
A flattened, rectangular tube with four walls, a top, a bottom and two sides, with each terminal end open to provide a pathway for airflow through the flattened, rectangular tube;
Said terminal ends oriented, when the apparatus is installed, such that the first terminal end serves as an intake for air to flow into, and the second terminal end serves as an outflow for air passing through said flattened, rectangular tube;
Said intake terminal end having a width twice that of the outflow terminal end,
And the body of the wiper apparatus having at least two 90 degree bends between the intake terminal end and the outflow terminal end.

6. A passive lens wiper apparatus according to claim 5, further comprising:
Said intake terminal end tapering from a width twice that of the outflow terminal to a width equivalent to the outflow terminal prior to a second 90 degree bend.

7. A passive lens wiper apparatus according to claim 5, further comprising:
Said 90 degree bends in the body of the flattened, rectangular tube positioned such that the first 90 degree bend conforms to a first corner of a camera housing, and the second 90 degree bend conforms to a next consecutive corner of a camera housing, wherein the outflow terminal end directs airflow across the surface of a camera housing when said flattened, rectangular tube with at least two 90 degree bends is attached to a camera housing.

8. A passive lens wiper apparatus according to claim 5, further comprising:
Said flattened, rectangular tube configured to be affixed to a camera housing through any of a variety of construction means including screws, adhesives, welding, or other such construction methods useful for joining together outdoor, ruggedized equipment articles.

9. A passive lens wiper apparatus comprising:
A flattened, rectangular tube with four walls, a top, a bottom and two sides, with each terminal end open to provide a pathway for airflow through the flattened, rectangular tube;
Said terminal ends oriented, when the apparatus is installed, such that the first terminal end serves as an intake for air to flow into, and the second terminal end serves as an outflow for air passing through said flattened, rectangular tube;
Said intake terminal end having a width twice that of the outflow terminal end,
And the body of the wiper apparatus having at least three 90 degree bends between the intake terminal end and the outflow terminal end.

10. A passive lens wiper apparatus according to claim 9, further comprising:
Said intake terminal end tapering from a width twice that of the outflow terminal to a width equivalent to the outflow terminal prior to a second 90 degree bend.

11. A passive lens wiper apparatus according to claim 9, further comprising:
Said 90 degree bends in the body of the flattened, rectangular tube positioned such that the first 90 degree bend conforms to a first corner of a camera housing, and the second 90 degree bend conforms to a next consecutive corner of a camera housing, and the third 90 degree bend conforms to a next consecutive corner of a camera housing, wherein the outflow terminal end directs airflow across the surface of a camera housing when said flattened, rectangular tube with at least three 90 degree bends is attached to a camera housing.

12. A passive lens wiper apparatus according to claim 9, further comprising:
Said flattened, rectangular tube configured to be affixed to a camera housing through any of a variety of construction means including screws, adhesives, welding, or other such construction methods useful for joining together outdoor, ruggedized equipment articles.
